(19) United States
(12) Patent Application Publication
(10) Pub. No.: US 2009/0000320 A1
(43) Pub. Date: Jan. 1, 2009

(54) Chilled Liquid Dispensers

(76) Inventors: Philip Andrew Walton, Bishop Auckland (GB); Jamie Sellors, Bishop Auckland (GB); Bob Taylor, Bishop Auckland (GB); James Priestly, Bishop Auckland (GB); John Malcolm Elliott, Bishop Auckland (GB)

Correspondence Address: Law Office of Ira S. Dorman, 330 Roberts Street, Suite 200, East Hartford, CT, 06108, US

(21) Appl. No.: 12/086,739

(22) PCT Filed: Dec. 15, 2006
(86) PCT No.: PCT/GB2006/004685

§ 371 Date: Jun. 18, 2008

(30) Foreign Application Priority Data
Dec. 20, 2005 (GB) 0525925.4

(51) Int. Cl. F25C 1/00; B67D 5/62; F25C 5/08

(52) U.S. Cl. 62/137; 222/146.6; 62/351

(57) ABSTRACT

The dispenser includes a bottle connector 5 for releasable sealing engagement with a neck formed on an inverted bottle 3, and a water path 6 conducts liquid from the bottle to a reservoir 7 via an optional water pump 41. The reservoir 7 is received in a thermal receptacle incorporating an evaporator plate 13 for producing ice within a bottom chamber 103 of the reservoir. The evaporator plate incorporates an electrical heating element 105 for periodically freeing the ice which enters an upper inlet chamber 100 and an ice chamber 101 separated by a baffle. Optical sensors A, B and C control ice generation. Ambient water entering the inlet chamber 100 is cooled to a temperature as low as 4° C. The chilled water then enters the ice chamber 101, from which ice-cold water can be dispensed close to zero ° C. A diverter flap 112 allows the inlet chamber 100 to continue receiving ice when the ice chamber 101 is full.

### TECHNICAL FIELD OF THE INVENTION

This invention relates to chilled liquid dispensers of the kind in which a liquid (usually water) is supplied from a bottle to a discharge outlet via a reservoir system in which the liquid is cooled.

### BACKGROUND

In such dispensers the water must remain in the reservoir system for a certain period of time in order to achieve the desired dispensing temperature. After sufficient time has elapsed the water within the reservoir system will eventually reach the target temperature, but the amount of time required depends on a number of factors, including the capacity of the reservoir, the power of the cooling system, and the effectiveness of any heat insulation surrounding the reservoir system.

It is known that maintaining a reserve of ice in a cooling reservoir provides a thermal buffer which can provide additional cooling capacity when a large influx of ambient water occurs due to a significant volume of chilled water being dispensed. Even so, it is difficult to dispense any significant volume of water at near-zero temperatures. If water is drawn from the top of the reservoir the ice-cold water already in the reservoir immediately mixes with ambient water entering the reservoir. On the other hand, if water is drawn from the bottom of the reservoir the minimum dispensing temperature is 4° C. This is because the density of water is highest at this temperature. Since water of the same densities mix together, water below 4° C. will always mix with warmer water of the same density to produce an average temperature of around 4° C.

The present invention seeks to provide a new and inventive form of chilled liquid dispenser which allows greater volumes of liquid to be dispensed at a temperature which is below the temperature at which the liquid is at its maximum density.

### SUMMARY OF THE INVENTION

The present invention proposes a chilled liquid dispenser having:
a bottle connector for releasable sealing engagement with a neck formed on an inverted bottle;
a reservoir system which includes:
   an inlet chamber for receiving ambient liquid from the bottle connector and in which the liquid is cooled, said inlet chamber having top and bottom regions, and
   an ice chamber which is arranged to receive cooled liquid from the inlet chamber, said ice chamber having top and bottom regions;
an ice generator for generating frozen liquid within the ice chamber; and
a passage for conducting ice-cold liquid from the ice chamber to a discharge outlet via a dispense valve;
   characterised in that
      cooled liquid from the bottom region of the inlet chamber is conducted to the bottom region of the ice chamber via an intermediate passageway such that said cooled liquid undergoes further cooling within the ice chamber.

Upon entering the inlet chamber the ambient liquid is cooled to a temperature which may be close to its temperature of maximum density. When the chilled water enters the ice chamber it is subjected to further cooling down to its freezing temperature without mixing with ambient liquid, so that significantly higher volumes of ice-cold liquid may thus be dispensed.

The ice generator may include a cooling system which is arranged to cause the liquid to freeze on an internal surface of the reservoir system, and from which frozen liquid is periodically removed. Heating means may be operated periodically to free pieces of frozen liquid. Such an arrangement may produce multiple thin sheet-like pieces of ice, which produce maximum cooling of the liquid.

In a preferred arrangement the inlet chamber communicates with the ice chamber via a bottom chamber which is disposed below the inlet chamber and the ice chamber.

### BRIEF DESCRIPTION OF THE DRAWINGS

The following description and the accompanying drawings referred to therein are included by way of non-limiting example in order to illustrate how the invention may be put into practice. In the drawings:

FIG. 1 is a schematic diagram showing a chilled liquid dispenser in accordance with the invention;

FIG. 2 is a general view of a replaceable ice generation assembly and evaporator unit for use in the dispenser; and

FIG. 3 is a schematic diagram showing an alternative reservoir system for use in the chilled liquid dispenser.

### DETAILED DESCRIPTION OF THE DRAWINGS

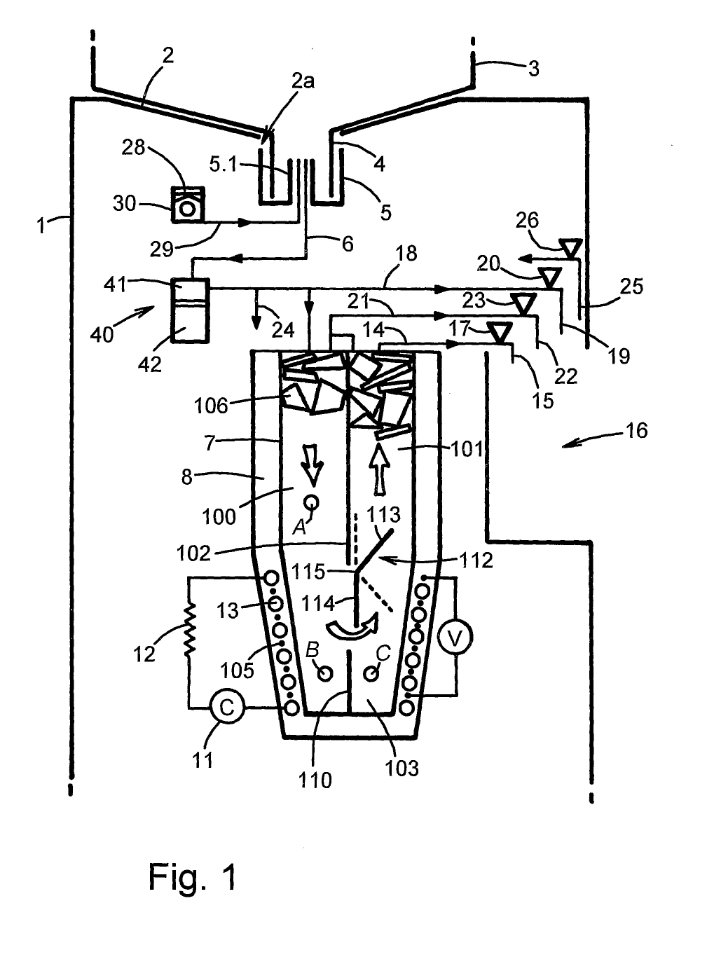

FIG. 1 shows, in schematic form, a bottled liquid dispenser of the kind which is generally referred to as a water cooler. The water cooler includes a housing 1 which is provided with a dish-like lid 2 forming a seat for a water bottle 3 which is mounted in an inverted position with its neck 4 inserted through an aperture 2a in the lid. Prior to use, the neck of the bottle is provided with a closure cap (not shown). When the bottle is mounted on the seat 2, the cap becomes sealingly engaged with a bottle connector 5 which is mounted beneath the lid 2 and which incorporates a feed tube 5.1 for removing water from the bottle. A transfer passage 6 conducts liquid from the feed tube 5.1 to a reservoir 7 which is received in a thermal insulation jacket 8, formed of expanded polystyrene or other heat insulation material, within the housing 1. Water contained in the reservoir 7 may be cooled by a hermetic refrigeration system which includes a reciprocating or rotary compressor 11, an air-cooled condenser 12 and an evaporator 13 which is mounted in close thermal contact with the lower region of the reservoir 7. Alternatively, a thermoelectric refrigeration system can be used which includes a Peltier device. Ice-cold water is removed from the reservoir 7 via an outlet passage 14 which terminates in a discharge outlet 15 disposed above a dispensing recess 16 formed in the housing 1. Flow control is achieved by means of a dispense valve 17 which may be arranged for direct manual operation or indirect manual operation via an electrical switch and an electrically-powered actuator. An ambient water passage 18 connects the transfer passage 6 to a second discharge outlet 19 above the dispensing recess 16 via a second dispense valve 20 to provide a supply of water at room temperature. A supply of chilled water may also be obtained from the reservoir via a mixer passage 21 leading to a third discharge outlet 22 above the dispensing recess 16 provided with a third dispense valve 23. An further ambient water passage 24 leads from the transfer passage 6 to a hot tank of known form (not shown) to supply hot water to a fourth discharge outlet 25 located above the dispensing recess 16 with a fourth dispense valve 26. The four discharge outlets 25, 19, 22 and 15 thus provide a choice of dispensing temperatures, namely hot, ambient, chilled or ice-cold water.

The water pathways between the bottle 3 and the four discharge outlets are fully sealed to prevent contact with atmospheric air. On initial use, water flows through the water pathways from the bottle 3 to the four discharge outlets 25, 19, 22 and 15, and air is purged through the discharge outlets so that the water pathways become substantially filled with water. Water displaced from the bottle is replaced by air which enters the bottle through a microfilter 28 and an air passage 29 which leads into the bottle through the feed tube 5.1 separately from the water passage 6. A non-return valve 30 may be included in the air pathway to prevent leakage of water, e.g. due to expansion of air within the bottle.

Water may be transferred from the bottle 3 to the discharge outlets 25, 19, 22 and 15 by gravity. However, by employing a pump-operated pressure-feed system the discharge outlets may be located at a higher level, relative to the feed tube 5.1, than is possible in a gravity feed system. In one form of pressure-feed system an air pump (not shown) may be arranged to supply pressurised air to the bottle 3 via the microfilter 28, non-return valve 30 and air passage 29 to create a pressure head within the bottle. A pressure switch may be provided to sense the pressure in the air pathway, switching off the pump when a suitable operating pressure has been attained and switching the pump on again when the pressure falls. Alternatively, a pressure relief valve venting to atmosphere can be used to limit the air pressure in the system.

In the present water cooler a pressure-feed system is provided by a water pump 40 connected in the transfer passage 6 to pump water through the water pathways from the bottle 3 to the four discharge outlets 25, 19, 22 and 15, thus creating an increased pressure head for dispensing water. The pump 40 is formed in two parts, namely a disposable pumping section 41 and a fixed motor assembly 42. The two parts may be releasably but drivably connected, e.g. by means of a mechanical drive or magnetic coupling.

The reservoir 7 contains two upper chambers, 100 and 101 respectively, which are separated by a vertical baffle 102. Ambient water from transfer passage 6 enters the reservoir through the top of inlet chamber 100, and ice-cold water is removed through outlet passage 14 from the top of the outlet chamber 101, which forms a separate ice chamber. The two chambers 100 and 101 are mutually connected by a common bottom chamber 103 about which the evaporator 13 is disposed. During operation of the refrigeration system, water in the bottom chamber 103 is allowed to freeze adjacent to the evaporator 13, resulting in the formation of a layer of ice on the wall of the bottom chamber. When this occurs the refrigeration system is switched off and an electrical heater 105 is operated to warm the wall of the bottom chamber. This causes sheet-like pieces of ice 106 to separate from the wall of the reservoir so that they become free-floating within the reservoir. Due to their lower density, the pieces of ice rise to the top of the reservoir within the inlet and outlet chambers 100 and 101. Ambient water entering the inlet chamber 100 is cooled by the ice within the chamber 100, resulting in a temperature gradient from ambient at the top down to the densest water at the lowermost part of the bottom chamber 103. When water is drawn off from the outlet chamber 101 the densest water flows through the bottom chamber 103 into the outlet chamber 101, which is filled with ice. In this chamber the coolest water rises to the top whilst slightly warmer water at around 4° C. remains at the bottom chamber due to its higher density. The ice present within the outlet chamber 101 holds the temperature of the water at the top near to freezing, with the result that ice-cold water can be dispensed from the outlet chamber at a temperature of about 0° C. The result is that a significantly higher volume of ice-cold water can be dispensed from the outlet chamber.

Chilled water for dispensing from the discharge outlet 22 is obtained by mixing water from both of the upper chambers 100 and 101 in the passage 21.

The ice generation could be controlled by operating the refrigeration system and the heating element for alternate periods. However, since the ambient temperature may vary, more reliable operation may be achieved by providing sensors within the reservoir. Although temperature sensors may be used it is preferred to provide optical sensors A, B and C which detect the amount of ice present within the reservoir. Sensor A is positioned to detect when the inlet chamber 100 is substantially filled with ice. Sensors B and C are positioned to detect a buildup of ice on the opposite walls of the bottom chamber 103 below the respective inlet and outlet chambers 100 and 101. A light barrier 110 may be mounted in the bottom chamber 103 between the sensors B and C to prevent mutual light interference between the two optical sensors. When either of the sensors B or C detects the presence of ice the refrigeration system is switched off and the heater is turned on. This causes slivers of ice to release from the walls and float to the top of both inlet and outlet chambers. When sensors B and C detect that the ice has gone, after a time delay of around 15 seconds, the heater is switched off and the refrigeration system is switched back on. If the sensor A detects ice for more than a predetermined time the refrigeration system is switched off to stop further ice generation. In general, the inlet chamber will consume more ice than the outlet chamber since more energy is required to cool from ambient to 4° C. than to cool from 4° C. to zero. A pivoted flap 112 is therefore provided to divert pieces of ice freed from the bottom chamber 103 into the inlet chamber 100 when the outlet chamber 101 becomes full. The flap 112 comprises two angularly disposed planar sections 113 and 114, which are pivoted at 115 adjacent to the junction of the two sections. The flap is balanced such that it normally adopts the position shown in solid lines, with the lower section 114 disposed substantially vertically within the bottom chamber and the upper section 113 inclined upwardly within the outlet chamber 101. Ice may pass on both sides of the flap, rotating the flap to the position shown in dashed lines as is enters the outlet chamber. However, when the outlet chamber is full the flap is held in the second position such that the lower section 114 is inclined to divert any further ice into the inlet chamber.

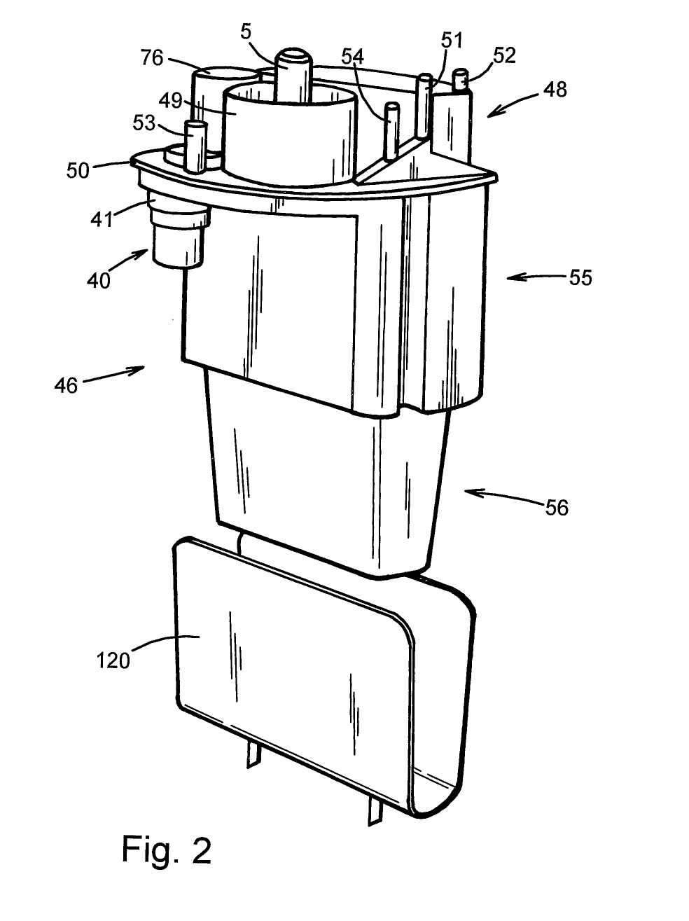

The feed tube 5.1, reservoir 7, the water passages 6 and 14 and the air passage 29 are preferably provided by a replaceable flow assembly 46, shown in more detail in FIG. 2. Such a flow assembly minimises heat losses and ensures reliable operation if external conditions change. The flow assembly 46 includes a semi-rigid injection moulded manifold 48 which is mounted on a reservoir moulding 55. The moulding 55 forms the upper part of the reservoir 7 while the lower part of the reservoir is provided by a vacuum formed bottom part 56 containing the bottom chamber 103. The manifold incorporates a receiver cup 49 into which the neck of the bottle is inserted in use, and which is upstanding from a generally planar support platform 50. The feed tube 5.1 projects upwardly within the cup 49 for insertion into the bottle. Three connecting spigots 51, 52 and 54 project upwardly from the platform 50, which may be connected via flexible tubing to the dispense valves 23, 17 and 20 via the discharge outlets 22, 15 and 19 respectively, referred to above. A further spigot 53, also projects upwards from the platform 50 for connection to the hot tank. The air filter 28 and non-return valve 29 are incorporated in a housing 76 which is formed on the platform 50 alongside the cup 49. The platform further incorporates the impeller assembly 41 of the water pump 40 described above.

The feed tube 5.1, which is positioned centrally of the receiver cup 49, contains an axial water passage to receive water from the bottle through the upper end of the feed tube. At the base of the feed tube, the axial passage joins a horizontal passage within the platform 50 leading to the upper end of the impeller assembly 41. A transfer passage leads tangentially from the impeller assembly and travels through the platform to the upper end of the reservoir moulding 55 to conduct water into the reservoir 7. In addition, the transfer passage communicates with ambient water passages leading to the connecting spigots 53 and 54. The platform 50 also contains the necessary passages which connect the reservoir to the chilled water outlet spigot 51 and the ice-cold water outlet spigot 52.

The opposing walls of the bottom part 56 diverge in an upward direction to ensure that ice does not become jammed in the bottom chamber when released from the walls by the heating element 105. The divergent shape also ensures that the bottom part is a close sliding fit within a U-shaped evaporator plate 120 held in the thermal insulation jacket 8 (not shown). The evaporator plate may have double skins which are roll bonded to form an enclosed evaporator passage that cools the evaporator plate. A serpentine evaporator tube could, alternatively, be used. The electrical heating element 105 may be applied to the inner or outer surface of the evaporator plate, with suitable electrical insulation.

Water displaced from the bottle is replaced by atmospheric air which can pass into the bottle through an air pathway which commences at the microfilter 28 within the air inlet housing 76. After passing through the non-return valve, air is conducted through a horizontal air passage in the bottom of the cup 49 to a second axial passage within the feed tube 5.1 to enter the bottle through the upper end of the feed tube 5.1.

The platform 50 may contain an additional drain passage to remove water spillages from the cup 49.

The feed tube, reservoir and associated water passages may be lined with an antimicrobial coating material, as disclosed in GB 2 396 418 B or International Patent Application No. PCT/GB2005/002572 (Ebac Limited).

The ice sensors A, B and C may each comprise a light emitting diode (LED) and a light dependent resistor (LDR) mounted within the insulation jacket 8 on opposite sides of the reservoir 7. The moulding 55 and bottom part 56 are both formed of transparent thermoplastics, so that when ice interrupts the light path through the reservoir the resistance of the LDR changes to signal the presence of ice.

The lid 2 may lift off the housing 1 or it can be hinged to the housing. The flow assembly 48 is inserted through the top of the housing after raising the lid 2. The reservoir 7 drops into the thermal receptacle 8 until the bottom part is snugly received within the evaporator plate 120. The manifold 48 may rest on a suitable support moulding which is fixed within the housing 1 and to which the electric motor assembly 42 of the water pump is permanently fixed. The motor 42 is arranged to rotatably drive the impeller assembly to move water from the bottle 3 into the reservoir 7 and create a sufficient pressure to ensure that water will issue from the discharge outlets 15, 19, 22 and 25 even when the water level within the bottle becomes low.

The water cooler is thus capable of providing the user with a wider choice of dispensing temperatures than is possible with conventional coolers, ranging from hot water for making hot beverages through to ice-cold water.

Although one embodiment of the flow assembly has been described in detail it will be appreciated that various modifications are possible within the scope of the invention. For example, the pump could be omitted in the case of a gravity feed system. The non-return valve in the air inlet to the bottle could take the form of a float valve. It will be appreciated that water could also be supplied from the water transfer passage 6 to a hot tank to be heated and dispensed through a separate discharge outlet above ambient temperature, for use in hot beverages for example. The dispense valves could take the form of pinch valves or poppet valves, either having direct manual activation or operated indirectly by means of electrically-powered actuators.

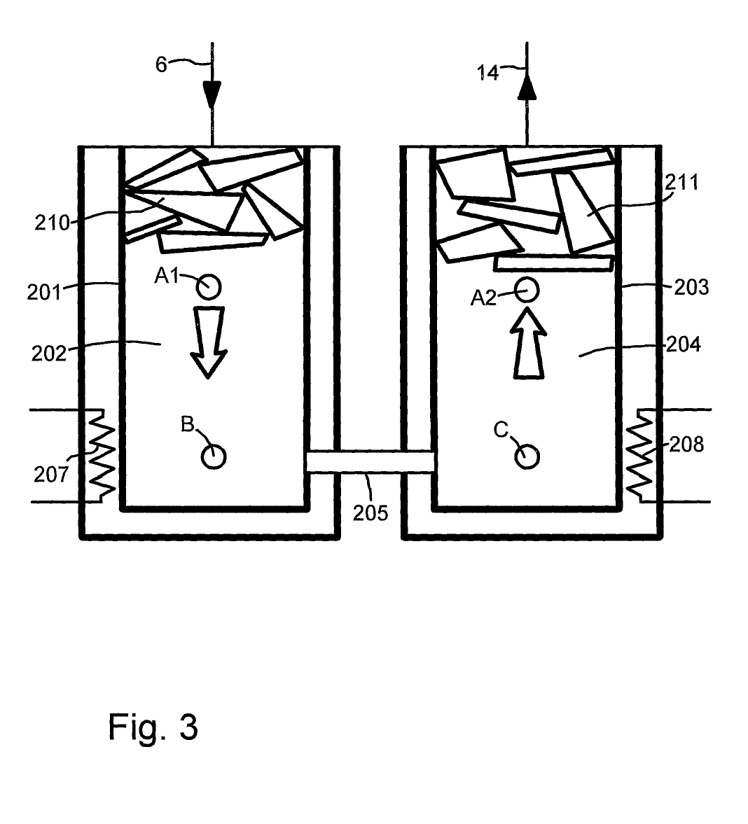

In a flow assembly such as the one shown in FIG. 2 the chambers 100, 101 and 103 are conveniently provided within a single reservoir. However, it is also possible to use two separate reservoirs interconnected at the bottom, as shown in FIG. 3. The other parts of the water cooler may be the same as the previous embodiment and will not therefore be described again. Ambient water from the passage 6 enters a first thermally-insulated reservoir 201 which provides an inlet chamber 202. Ice-cold water is removed through outlet passage 14 from the top of a second thermally insulated reservoir 203 which provides an outlet chamber 204. The bottom regions of the two chambers 202 and 204 are mutually connected by an interconnecting passage 205. Each reservoir 201, 203 is provided with a respective cooling system 207, 208. Since in the present invention the main function of the inlet chamber is to cool ambient water to around 4° C. it is not essential to provide ice in this chamber, although the presence of ice provides an additional cooling buffer to cope with a large inflow of ambient water. The cooling system 207 may be controlled by an ice sensor B to periodically release sheet-like pieces of ice 210 from the wall of the inlet chamber. Generation of ice 211 is similarly controlled within the outlet chamber 204 by means of an ice sensor C. The chambers 202 and 204 contain additional ice sensors A1 and A2 respectively to detect an accumulation of ice at the top of the respective chamber. If either sensor detects ice for more than a predetermined time the refrigeration system is switched off to stop further ice generation. Ambient water entering the inlet chamber 202 is cooled by the ice within the chamber, resulting in a temperature gradient from the top down to the densest water at the bottom. When water is drawn off from the outlet chamber 204 the densest and hence coldest water flows through the passage 205 into the outlet chamber 204. In this ice chamber the coolest water is found at the top where ice is present whilst slightly warmer and denser water remains at the bottom. Hence, ice-cold water can be dispensed at a temperature of about 0° C.

In a two reservoir system maximum efficiency is achieved by the use of separate cooling systems for the inlet and ice chambers, although in both of the embodiments described herein the use of a single cooling system or separate cooling systems is possible.

It will be appreciated that the features disclosed herein may be present in any feasible combination. Whilst the above description lays emphasis on those areas which, in combination, are believed to be new, protection is claimed for any inventive combination of the features disclosed herein.

* Watertrail is a registered trade mark of Ebac Limited.

1. A chilled liquid dispenser having:
a bottle connector (5) for releasable sealing engagement with a neck (4) formed on an inverted bottle (3);
a reservoir system which includes:
an inlet chamber (100; 202) for receiving ambient liquid from the bottle connector and in which the liquid is cooled, said inlet chamber having top and bottom regions, and
an ice chamber (101; 204) which is arranged to receive cooled liquid from the inlet chamber, said ice chamber having top and bottom regions;
an ice generator (13; 207, 208) for generating frozen liquid which is released into the ice chamber;
and
a passage (14) for conducting ice-cold liquid from the ice chamber to a discharge outlet via a dispense valve (15, 17);
characterised in that
cooled liquid from the bottom region of the inlet chamber (100; 202) is conducted to the bottom region of the ice chamber (101; 204) via an intermediate passageway (103; 205) such that said cooled liquid undergoes further cooling within the ice chamber.

2. A chilled liquid dispenser according to claim 1 in which the intermediate passageway comprises a bottom chamber (103) which is disposed below the inlet chamber (100) and the ice chamber (101).

3. A chilled liquid dispenser according to claim 2 in which the ice generator (13) is arranged to generate ice within the bottom chamber (103).

4. A chilled liquid dispenser according to claim 3 in which the reservoir system includes means (112) for controlling movement of pieces of frozen liquid from the bottom chamber into both the inlet chamber and the ice chamber.

5. A chilled liquid dispenser according to claim 4 in which the movement of pieces of frozen liquid is controlled by a diverter flap (112) which is arranged to divert frozen pieces into one of the upper chambers (100, 101) when the other upper chamber (101, 100) becomes full.

6. A chilled liquid dispenser according to claim 1 in which the inlet chamber (202) and the ice chamber (204) are provided by separate reservoirs (201, 203) which are joined by the intermediate passageway (205).

7. A chilled liquid dispenser according to claim 6 in which the inlet chamber (202) and the ice chamber (204) are provided with respective cooling systems (207, 208).

8. A chilled liquid dispenser according to claim 1 in which the ice generator includes a cooling system (11, 12, 13) which is arranged to cause the liquid to freeze on an internal surface of the reservoir system, and frozen liquid is periodically removed from the said surface to enter the ice chamber.

9. A chilled liquid dispenser according to claim 8 in which the ice generator includes heating means (105) which is operated periodically to free pieces of frozen liquid from said internal surface.

10. A chilled liquid dispenser according to claim 1 in which the reservoir system is provided with optical sensors (A, B, C) for detecting the presence of frozen liquid and which are arranged to control operation of the ice generator.
